(19) United States
(12) Patent Application Publication
(10) Pub. No.: US 2006/0256202 A1
(43) Pub. Date: Nov. 16, 2006

(54) Method and devicefor recording video data

(75) Inventor: Thomas Hohenacker, Stranberg (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Telcast Media Group GmbH, Muenchen (DE)

(21) Appl. No.: 10/547,276

(22) PCT Filed: Mar. 5, 2004
(86) PCT No.: PCT/EP04/02262

§ 371 Date: Jun. 14, 2006

(30) Foreign Application Priority Data
Mar. 5, 2003 (EP) 03005013.2

(51) Int. Cl. H04N 5/232

(52) U.S. Cl. 348/211.99

(57) ABSTRACT

The invention relates to a method for the recording of video data by means of at least one camera fixedly installed at a taking position and controllable to make different settings, wherein an image of the environment of the camera is presented at a display device disposed spatially remote from the taking location; at least one camera tracking is fixed by selection of at least a plurality of picture elements in the environmental image presented; a control command sequence for the camera is generated from the selected picture elements; and the camera is controlled to carry out the camera tracking in accordance with the control command sequence.

### CROSS-REFERENCE TO RELATED APPLICATIONS

This application is a National Stage of International Application No. PCT/EP2004/002262, filed on Mar. 5, 2004. The disclosure of the above application is incorporated herein by reference.

### FIELD AND BACKGROUND OF THE INVENTION

The invention relates to a method and to an apparatus for the recording of video data by means of at least one camera fixedly installed at a taking position and controllable to make different settings.

When controlling cameras, it is often desired that a camera automatically runs through a pre-determined movement profile, i.e. sequentially focuses on different pre-determined objects in the environment of the camera, with the movement track of the camera between the individual objects, i.e. the individual camera pans or tilts, the fixation times on the objects as well as further camera settings such as focus, focal length, aperture, etc., likewise having to correspond to specific pre-determined ideas of the operator.

It must be ensured for the setting of a specific movement profile—also called camera tracking in the following—that the picture section seen by the camera during the camera movement corresponds with the desired picture section at all times. If the fixing of the camera tracking is made on site, that is at the taking location, the respective operator can simply look through the viewfinder of the camera or onto a shot monitor displaying the instantaneous picture section in order to monitor the camera settings during the movement of the camera and, optionally, during the changing of the focal length of the camera, i.e. during zooming—that is generally during the changing of camera settings.

A direct feed back of this type is, however, not always possible when the camera is intended to be controlled from a spatially remotely disposed location. On the transmission of control commands to the camera, on the one hand, and of image data back to the user, on the other hand, time delays can occur in the transmission which make a direct response of the camera required for an exact guidance of the camera impossible.

### SUMMARY OF THE INVENTION

It is the object of the invention to provide a possibility for the recording of video data, wherein a control of the camera, including a precise fixing of movement profiles of the camera, is ensured which is as precise and free of delay as possible in a manner which is as simple and as reliable as possible, with this in particular also being possible from locations disposed spatially remotely from the location of the camera.

This object is satisfied, on the one hand, by the features of the independent method claim and in particular in that an image of the environment of the camera is presented at a display device disposed spatially remotely from the recording location; that at least one camera tracking is fixed by selection of at least a plurality of picture elements in the environmental image presented; in that a control command sequence for the camera is generated from the selected picture elements; and in that the camera is controlled to carry out the camera tracking in accordance with the control command sequence.

The object underlying the invention is moreover satisfied by the features of the independent apparatus claim and in particular in that at least one camera fixedly installed at a taking location and controllable to make different settings, a display device which is disposed spatially remotely from the taking location and at which an image of the environment of the camera can be presented, a selection device by means of which at least a plurality of picture elements in the presented environmental image can be selected, a control device by means of which a control command sequence for the camera can be generated from the selected picture elements and a data transmission path via which the control command sequence can be transmitted to the camera for the carrying out of the camera tracking are provided.

In accordance with the invention, it is not necessary to track and to monitor the effects of changes of camera settings “live”, but an image of the camera environment is rather worked with, with the presentation of this environmental image generally being able to take place at any desired location. Picture elements are selected in the presented environmental image to fix the camera tracking which are in particular those regions of the camera environment which should move into the field of view of the camera during the camera tracking to be fixed. A picture element can be a specific object in the camera environment, e.g. a landscape feature or a building, or a large region which contains a specific object, with e.g. the operator fixing the position of the object in the picture section seen by the camera during the camera tracking and coinciding with the selected region by selecting the region.

The presentation of the environmental image can generally take place in any desired size, with it being sufficient for the environmental image only to be presented section-wise and to be scrolled through on the selection of the picture elements. A zoom function can in particular be provided with which regions of interest of the environmental image are zoomed in on to make the selection of a picture element in the presentation enlarged in this manner.

The camera settings which can be changed by means of control commands are in particular the alignment of the camera and its zoom setting or focal length setting. The camera can, for example, be instructed by means of the control commands to carry out pan/tilt movements by a respectively pre-determined measure and at a pre-determined speed or—likewise at a pre-determined speed—to change from a wide-angle shot to a telephoto shot.

To convert the selected picture elements into the corresponding control commands, the known properties or the known behavior of the camera on a change in camera settings can be used so that e.g. a calculation can be made on how an electric motor provided for the panning/tilting of the camera has to be controlled so that the camera pans and tilts so far, starting from a first picture element of interest, about a vertical and a horizontal axis that a second picture element of interest is located e.g. in the upper right hand corner region of the picture section seen by the camera with a specific zoom setting.

Use can be made of a known association between the camera setting and the picture section seen by the camera for the generation of the control command sequence. Which section of the actual camera environment the camera “sees” at the respective camera setting can e.g. be determined from the size and the direction of the spatial angular region seen by the camera for each camera setting.

In accordance with the invention, neither the taking of the environmental image and the selection of the picture elements nor the generation of the control command sequence and the control of the camera in accordance with the control command sequence need to take place simultaneously. The environmental image can rather be recorded and be presented at any desired later time for the selection of the picture elements and so for the fixing of the camera tracking. A control command sequence can accordingly be generated from selected picture elements and first be stored before this control command sequence is used to control the camera at any desired later time.

Consequently, in accordance with the invention, the fixing of camera tracking movements can take place completely independently of the actual camera and its location both in a time respect and in a spatial respect, with nevertheless a precise camera guidance being ensured since the selection of the picture elements, and thus the fixing of the camera tracking, takes place in the image presentation of the camera environment and thus with reference to the actual environment of the camera and it is thus ensured that the selected picture elements are converted into such control commands which result in the desired picture sections during the camera tracking carried out in accordance with just these control commands.

The invention is particularly advantageous in conjunction with cameras in whose environment sufficient regions exist which are not subject to any time changes since it is then not necessary—or is only necessary in comparatively large time intervals—to up-date the environmental image to be presented. The invention is therefore particularly advantageous in conjunction with cameras installed outdoors with which landscape shots or shots of towns or selected buildings should be made available.

The environmental image can be recorded by means of the camera itself. The conversion of the selected picture elements into the control command sequence is hereby simplified since differences in the properties of the camera taking the environmental image, on the one hand, and of the actual camera to be controlled to carry out the camera tracking, on the other hand do not have to be taken into account.

At least one additional camera can be provided which is preferably made as a panorama camera and covers a visual range with a horizontal angle of vision of, for example, 180°. The movement of the additional camera can be fixedly coupled to the movement of the actual camera so that the visual range of the additional camera depends on the position of the actual camera. Alternatively or additionally to an environmental image taken by means of the actual camera, an environmental image can also be made available by the additional camera in which a camera tracking for the actual camera can likewise be fixed.

The fact must admittedly then be taken into account for the generation of the control command sequence for the actual camera—in particular with respect to the different angles of vision of the two cameras—that the environmental image serving for the fixing of the camera tracking was taken with the additional camera and not with the actual camera itself. However, the additional camera can be of advantage if an image of the environment which is as up-to-date as possible should serve as the basis for the fixing of the camera tracking in order e.g. to be able to take account of poor visual conditions, for example due to the weather, prevailing in specific regions. This is particularly advantageous when the environmental image provision by means of the actual camera is comparatively costly and time-intensive. The use of an additional camera covering a large visual range in the manner of a door spyhole in particular has the advantage that a compilation of the environmental image from individual images is not necessary, but rather the fixing of the camera tracking can take place in a single sufficiently large image of the additional camera.

Provision can furthermore be made for the environmental image to be compiled from a plurality of individual images taken by means of the camera itself. The environmental image can be a panorama view which preferably covers a horizontal angular range of 360°.

Provision can furthermore be made for a camera tracking to be selected from a camera tracking archive including a plurality of different, previously generated control command sequences for the control of the camera.

It is thus possible, for example, to fix a plurality of different camera tracking movements with reference to the presented environmental image and to store the corresponding control command sequences which can then be called up as required at a later time to control the camera accordingly.

Different camera settings can be achieved by movement of the camera, in particular panning/tilting about a vertical and/or horizontal axis, by changing the focal length of the camera, by changing the camera aperture and/or by changing the focus of the camera.

Provision can furthermore be made for specific properties of the picture elements and/or properties of the camera panning/tilting to be carried out between the picture elements to be fixed in addition to the picture elements in the environmental image. These properties are e.g. a speed profile and/or an acceleration profile of changes of at least one camera setting, in particular of the camera alignment, the focal length of the camera, the camera aperture and/or of the focus of the camera.

Not only specific “fulcrums” of the camera tracking can thereby be fixed with the picture elements selected in the environmental image, but it can moreover be directly pre-set at which speed and/or at which acceleration the individual picture elements are moved to sequentially. Furthermore, for example, automatically specified picture elements can be directly overexposed or underexposed during the camera tracking. Direct blur effects can furthermore e.g. be automatically integrated into the camera tracking.

Provision can furthermore additionally be made for the triggering of at least one camera function to be fixed. A triggerable camera function is, for example, a white balance which is e.g. carried out automatically at the start of the camera tracking.

With the taking apparatus in accordance with the invention, the display device and the control device can be components of a central station with which a plurality of taking positions with at least one camera is associated.

For example, a plurality of cameras spread all over the world and respectively fixedly installed at a taking position can thus be controlled from one single central station in that one or more camera tracking movements are respectively defined with respect to an image of the respective camera environment presented at the central station and are then carried out at a respectively desired point in time by transmission of the corresponding control command sequences in order in this way to obtain image data from the whole world e.g. in the form of short video clips which can, for example be compiled to form a program and be offered to television broadcasters after transmission back to the central station.

It is a particular advantage of the invention that it permits an automatic compilation of a live program or at least of a quasi-live program in which use is made of video data of a plurality of cameras which can each provide video data in accordance with previously fixed camera tracking movements. For this purpose, a recording plan can first be prepared with which it is fixed via which camera transmission is made when and with which camera tracking movement, with it in particular being able to be ensured that a switch is made from one camera to another camera at precisely definable times, e.g. respectively at the end of the camera tracking movement previously fixed for the camera, whereby cuts perceived as irritating can be avoided.

Professional programs of high quality with a simultaneously fully automatic operation can be produced in a technical and esthetic regard by this possibility in accordance with the invention for the automatic coordination of a global camera network generally including as many cameras as desired which can basically be controlled to make any desired camera tracking movements.

A commercial PC can be use as the control device, with the PC monitor serving as the display device and a corresponding peripheral device such as a keyboard and/or a mouse serving as the selection device.

The data transmission path for the transmission of the control command sequence to the camera can generally be any desired telecommunication link. Use can in particular be made of an existing cellular telephone network and/or of a landline telephone network. The same telecommunication link can be used for the re-transmission of the video data recorded by means of the camera, with an intermediate storage or intermediate buffering of the image data being able to be carried out at the taking position, that is at the location of the camera, to wait for cost-favorable transmission times.

The camera can include at least one detection device with which a reference value serving as a reference point for a changeable camera setting can be detected. A detection device of this type includes e.g. a senor with which the reaching of a 0° alignment of the camera can be detected with respect to which a respectively required degree of a pan of the camera about a vertical axis is calculated and an electric motor provided for the panning/tilting of the camera is controlled.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 schematically illustrates a taking apparatus in accordance with an embodiment of the invention which is designed for the carrying out of a taking process in accordance with the invention; and

FIG. 2 schematically illustrates a part of a presented environmental image with different picture sections seen by the camera for the explanation of the invention.

### DETAILED DESCRIPTION OF THE PREFERRED EMBODIMENTS

The following description of the preferred embodiment(s) is merely exemplary in nature and is in no way intended to limit the invention, its application, or uses.

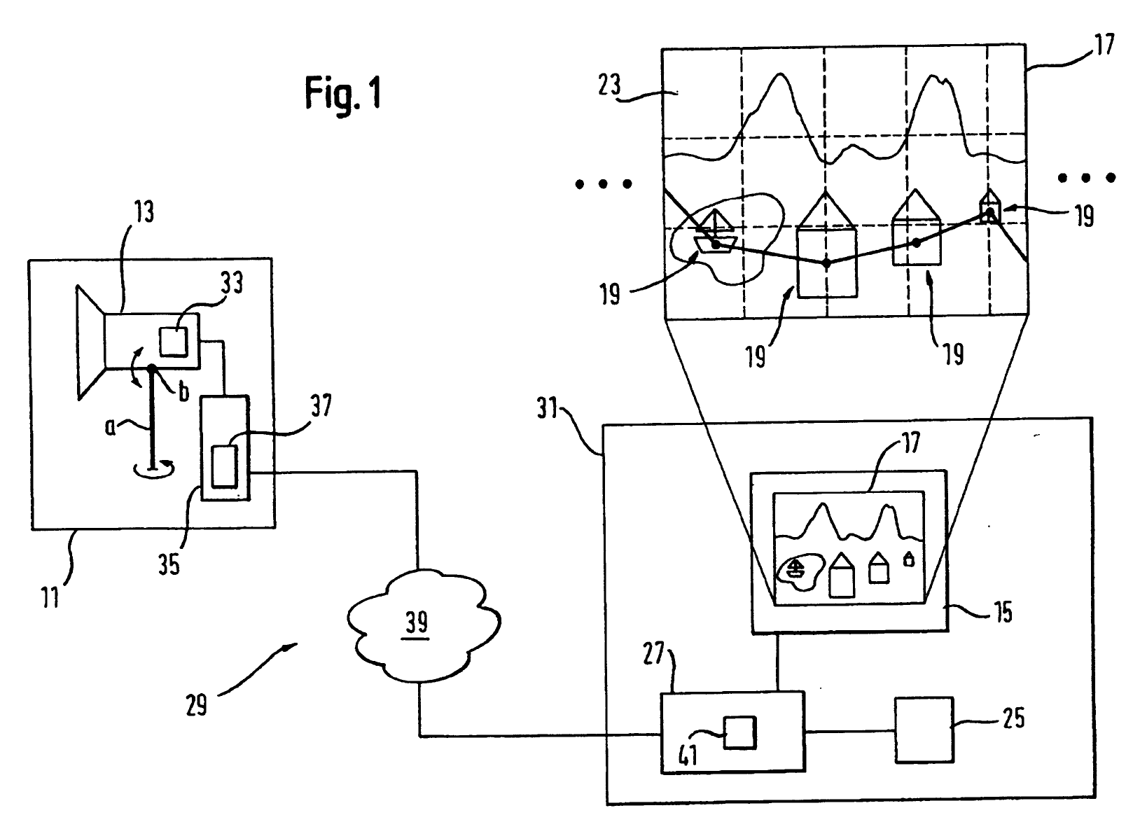

In accordance with FIG. 1, the taking apparatus of the invention includes a camera 13 fixedly installed at a taking position 11. The camera 13 can be panned about a vertically extending axis and tilted about a horizontally extending axis b. For this purpose, the camera 13 is provided with electric stepper motors which pan/tilt the camera 13 about a respectively desired angular range at a very high positioning precision, and indeed in each case with respect to a pre-determined zero angle or reference angle whose reaching can be detected in each case by a detection device 33 in the form of a suitable sensor.

Further changeable camera settings are the focus of the camera 13, its focal length and its aperture.

The control of the camera 13 and in particular of the stepper motors takes place by a local control device 35 which is located at the position of the camera and can be integrated in the camera 13. The control device 35 moreover includes a memory device 37 in which video data recorded by means of the camera 13 can be stored.

The local control device 35 of the camera 13 can communicate via a data transmission path 29, which includes a cellular telephone network and/or a landline telephone network 39, with a central control device 27 of a central station 31 which is disposed spatially remote from the taking position 11 and can generally be located at any desired position and at any desired large distance from the taking position 11.

The central control device 27, for example a commercial PC, has a display device 15, e.g. in the form of a commercial monitor, as well as a selection device 25, in particular in the form of a keyboard and/or of a mouse.

An image of the environment of the camera 13 installed at the taking position 11 is stored in a memory unit 41 of the computer 27. This environmental image 17 shown only partly in FIG. 1 can be presented on the monitor 15 to fix one or more camera tracking movements for the camera 13 installed at the taking position 11 with reference to this environmental image 17. Depending on the view size set at the monitor 15 and preferably changeable, the environmental image 17 is presented in full or in part, i.e. the selection described in the following of picture elements for the fixing of camera tracking movements can take place with reference to the total environmental image 17 or to individual sections thereof.

As indicated in the enlarged representation of FIG. 1, the environment of the camera 13 in this example used only for general explanation is a landscape with a mountain range in the background, a lake and a sailboat as well as three buildings disposed at different distances from the location of the camera 13. The environmental image 17 is a processed 360° panorama view, i.e. the camera 13 can be panned about the vertical axis a over an angular range of 360° and can thus provide a complete 360° view of its environment.

The environmental image 17 stored in the memory unit 41 of the central control device 27 and presented on the monitor 15 was previously taken by the camera 13 itself, and indeed in the form of a plurality of individual images 23 which are compiled to form the environmental image 17. The lattice network formed by the individual images is indicated by broken lines.

To fix a camera tracking movement, the operator located at the location of the central station 31 selects a plurality of picture elements 19 sequentially using a mouse or keyboard 25 of the computer 27 which should automatically be traveled to sequentially by the camera 13 on the later carrying out of the camera tracking. In the example shown, the sailboat on the lake should first be focused on, subsequently the building disposed in the foreground, then the building located at the intermediate distance and then the building located at the largest distance from the camera location. The operator can furthermore fix whether—and if so how long—the camera 13 should remain at a selected image element 19 and how long a pan/tilt from one picture element 19 to the next picture element 19 should take. Not only the duration, but generally also the extent of the pan/tilt can generally be selected as desired, with the individual camera pans extending in a straight line from picture element 19 to picture element 19 in the example shown in FIG. 1, but with any desired track curves generally being possible.

The selection of a picture element can take place by selection of an image element, e.g. simply by clicking, or of a picture region, e.g. by “frame dragging”. It can be set that, when a picture element is selected, this automatically represents the center of the picture section seen by the camera 13 and its size must additionally be fixed so that the corresponding focal length setting can be determined. If a picture region is selected, it can be set that this picture region simultaneously represents the picture section seen by the camera 13.

Furthermore, the operator can set different properties which are possible with the respectively used camera 13 both for the selected picture elements 19 and for the individual camera pans/tilts. The focal length of the camera, the camera aperture and/or the focus of the camera can thus be defined, for example, for each picture element 19 to achieve specific effects.

The speeds and/or the accelerations of the corresponding camera movements can also be pre-set. Generally, speed profiles and/or acceleration profiles for the fixing of the camera tracking can be pre-set for all changes which can be made to the settings of the camera.

The changeable camera settings do not only have to be the camera alignment, it is rather the case that the focal length of the camera, the camera aperture and/or the focus of the camera can respectively also be changed in accordance with a pre-determined speed profile or acceleration profile during the camera tracking.

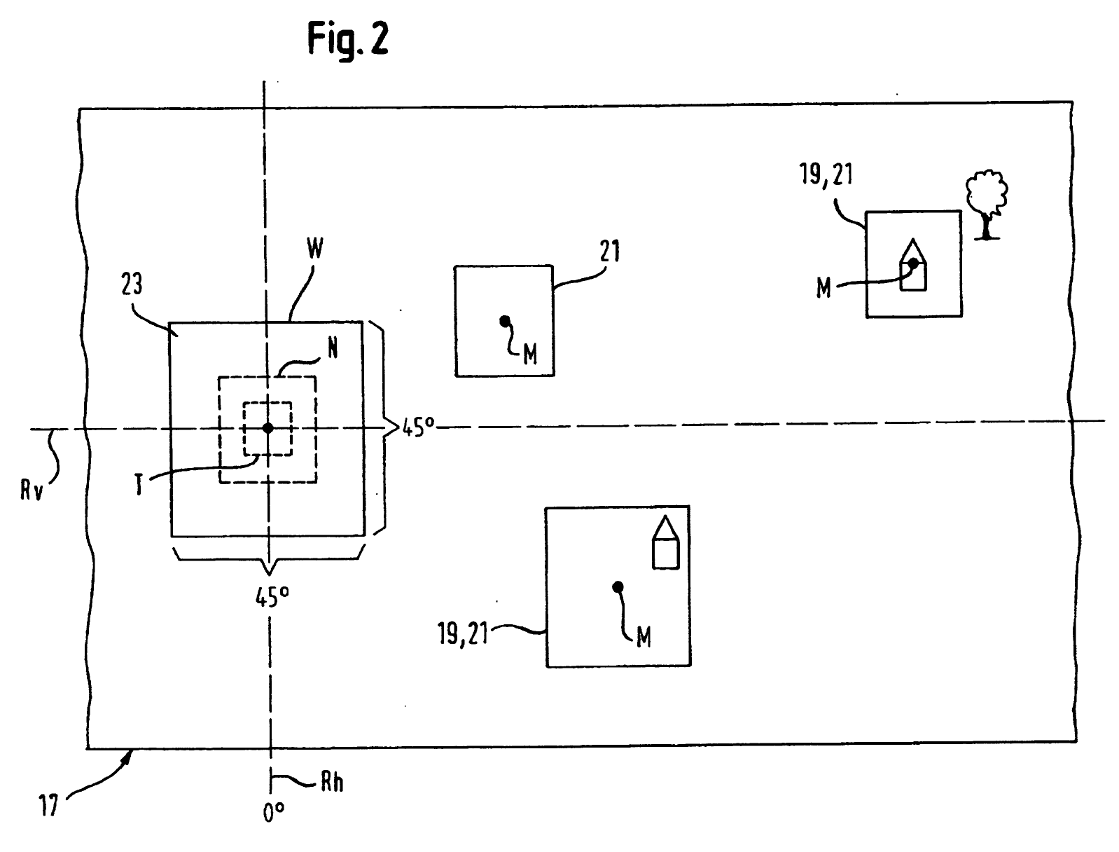

It will be explained by way of example in the following with reference to FIG. 2 how control commands can be generated from the selected picture elements 19 with knowledge of the known properties of the camera 13, said control commands ensuring—when the camera 13 is controlled correspondingly—that the selected picture elements 19 are traveled to on the carrying out of the camera tracking and have the desired position and size in the picture section respectively seen by the camera 13.

In FIG. 2, a part of an environmental image 17 is shown which corresponds to the maximum visual range of the camera 13. At the maximum wide-angle setting W, the camera 13 has an angle of view of 45° in both the vertical direction and the horizontal direction, can be panned in the horizontal direction—that is about the vertical axis a—by 360° and can be tilted in the vertical direction—that is about the horizontal axis b—by 90°. The reference angle Rh of the horizontal movement and Rv of the vertical movement can each be detected by sensors of the camera 13 and serve as reference values for the calculation of the control commands used for the control of the camera stepper motors. The reference angle Rv corresponds to a horizontal alignment of the camera 13 with respect to which the camera 13 can be tilted upwardly by 45° and downwardly by 45°.

In this example, the environmental picture 17 can consequently be compiled of 3×8=24 individual images 23 which are each taken at a maximum wide-angle setting W by means of the camera 13.

The corresponding angle of view is moreover known not only for the maximum wide-angle setting W, but for any focal length of the camera 13 which can be set, said angle of view amounting, for example, to approximately 10° with a maximum telephoto setting T and to approximately 20° at a mean normal setting N.

If—as in the example of the picture element on the left in FIG. 2—the picture element selected by the operator in the environmental image 17—here a picture element selected by “clicking”—should coincide with the center of the picture section 21 seen by the camera 13, the camera 13 only has to be panned/tilted about a corresponding angle in the horizontal direction and in the vertical direction, since the position of the reference values Rh and Rv in the environmental image 17 as well as the angular spacing of the center of the picture section seen by the camera 13 to the reference value Rh and to the reference value Rv are known for each alignment of the camera 13. To fix the picture section 21, the size of the picture section 21 must be fixed in addition to the center M so that the corresponding focal length setting can be determined.

It is shown by the example of the picture element 19 on the right in FIG. 2—here a larger picture region—that the operation can moreover set that a landscape feature—in this example a tree—should not be seen in the picture section 21 if, during the later camera tracking, the center M of the picture section 21 seen by the camera 13 coincides with the center M of the selected picture region 19 formed by a building here. For this purpose, the operator can drag a frame about the building in the environmental image 17 whose size is selected such that the tree lies outside this frame.

Control commands for the camera alignment and for the focal length setting which ensure that the picture section seen by the camera during the later camera tracking coincides with the picture region 19 are then computed by means of corresponding software from the selected picture region 19 fixed by the frame. The corresponding focal length setting of the camera 13 is therefore also simultaneously fixed using the frame.

In the example in the middle in FIG. 2, an environmental feature of interest—here again a building—should lie in the right hand upper corner of the picture section 21 later seen by the camera 13 during the camera tracking so that the operator drags a frame around a centre M to fix a picture element 19 in the environmental image 17, with the frame admittedly not coinciding with the building, but still surrounding the building. The control commands which provide the required camera movements and the required setting of the camera focal length are in turn calculated from these pre-settings. The position of the frame 19 in the environmental image 17 determines the camera alignment, whereas the size of the frame 19 determines the camera focal length.

All the control commands generated in this manner from the selected picture elements 19 are compiled to form a control command sequence and stored in the memory unit 41 of the central control device 27. For the carrying out of the corresponding camera tracking movements, the respective control command sequence is then transmitted via the data transmission path 29 to the local control device 35 which controls the camera 13 correspondingly at a likewise pre-settable time, whereupon the video data are recorded with the desired camera tracking.

The control command sequences can also be stored in the memory device 37 of the local control device 35. A command then only has to be transmitted from the central station 31 to the local control device 35, said command containing a desired time, for example, at which the camera tracking should be started in addition to an identification of the camera tracking to be carried out.

That control command sequence which is carried out take record the individual images 23 to be presented for the compilation at the central station 31 as the environmental image 17 can itself be generated at the central station 31 with reference to a previously recorded environmental image 17.

There are further recording positions (not shown in FIG. 1) at which at least one respective camera is likewise fixedly installed and with which the central station 31 can likewise communicate in order also to be able to fix camera tracking movements for these respective cameras with reference to a corresponding environmental image.

The cameras 13 can be components of a common network for the fully automatic production of live programs which are compiled from the video data of the individual cameras 13 in accordance with a previously prepared recording plan with which e.g. the camera tracking movements to be carried out by the individual cameras 13 and the order can be pre-set in which the video data of the individual cameras 13 should form the program.

The camera tracking movements can also generally be fixed as desired in a time respect. A fast-motion function can e.g. thus be realized in which a specific track curve is not run through by the camera in a “real time” corresponding to a “normal” pan/tilt, but a respective single image is rather taken at pre-settable time intervals of, for example, some seconds and the camera is moved by a pre-set amount on the track curve between the taking of two images. The track curve can generally be traveled over in any desired fine gradation within the framework of the technical possibilities of the respective camera, with extremely small pan/tilt movements of e.g. 1/10,000° between two individual images also being possible. The running through of the total track curve, that is the camera tracking, can take a plurality of hours, e.g. 12 or 24 hours. The individual images can be compiled in the camera and then be transmitted to a central station as a film showing, for example, half a day or a whole day at the location of the camera.

Provision can be made by a special control command within the framework of a camera tracking for the camera to focus automatically or by remote control on an adjustment area installed on site by means of which specific functions of the camera can be checked or the camera can be matched to the instantaneous conditions on site. A white balance of the camera can e.g. be carried out in this manner. The adjustment area provided for this purpose and especially made for this purpose can e.g. be arranged at the camera foot or at another position where it lies outside the visual range of the camera required for the “normal” camera tracking movements.

Provision can furthermore be made for the camera to travel automatically into a protective position after running through a track curve, i.e. at the end of a camera tracking movement, in which it and in particular the optical receiving system is protected as well as possible from the weather and from other external influences. The control commands required for this are preferably already each integrated into the control command sequences generated by the fixing of the camera tracking, which preferably takes place automatically.

The description of the invention is merely exemplary in nature and, thus, variations that do not depart from the gist of the invention are intended to be within the scope of the invention. Such variations are not to be regarded as a departure from the spirit and scope of the invention.

### REFERENCE NUMERAL LIST

11 taking position
13 camera
15 display device
17 environmental image
19 picture element
21 picture section
23 individual image
25 selection device
27 central control device
29 data transmission path
31 central station
33 detection device
35 local control device
37 memory device
39 cellular telephone network, landline telephone network
41 memory unit
a vertical pan axis
b horizontal tilt axis

1. method of recording of video data by means of at least one camera (13) fixedly installed at a taking position (11) and controllable to make different settings, comprising:
presenting an image (17) of an environment of the camera (13) at a display device (15) disposed spatially remote from the taking position (11);
fixing at least one camera tracking movement by selection of at least a plurality of picture elements (19) in the environmental image (17);
generating a control command sequence for the camera (13) from the selected picture elements (19); and
controlling the camera (13) in accordance with the,control command sequence for the carrying out camera tracking.

2. A method in accordance with claim 1, characterized in that the environmental image (17) is taken by the camera (13) itself.

3. A method in accordance with, claim 1, characterized in that a camera tracking movement is carried out for the taking of the environmental image (17) which was fixed with reference to an environmental image taken earlier.

4. A method in accordance with claim 1, characterized in that the environmental image (17) is compiled from a plurality of individual images (23) taken by the camera (13) itself.

5. A method in accordance with claim 1, characterized in that the environmental image (17) is a panorama view which preferably covers a horizontal angular range of up to 360°.

6. A method in accordance with claim 1, characterized in that the generation of the control command sequence takes place from the picture elements (19) selected while using a known association between the camera setting and the picture section (21) seen by the camera (13).

7. A method in accordance with claim 1, characterized in that the selection of the picture elements (19) takes place at a later point in time than the taking of the environmental image (17) in which the picture elements (19) are selected.

8. A method in accordance with claim 1, characterized in that the control of the camera (13) takes place in accordance with the control command sequence at a later point in time than the generation of the control command sequence from the selected picture elements (19).

9. A method in accordance with claim 1, characterized in that a camera tracking is selected from a camera tracking archive including a plurality of different, previously generated control command sequences for the control of the camera (13).

10. A method in accordance with claim 1, characterized in that different camera settings are achieved by movement of the camera (13), in particular panning/tilting about a vertical and/or horizontal axis, by changing the focal length of the camera, by changing the camera aperture and/or by changing the focus of the camera.

11. A method in accordance with claim 1, characterized in that properties of the picture elements (19) and/or of the camera pans/tilts to be carried out between the picture elements (19) are additionally set; and/or in that the triggering of at least one camera function, in particular of a white balance, is set.

12. A method in accordance with claim 11, characterized in that the properties include a speed profile and/or acceleration profile of changes of at least one camera setting, in particular of the camera alignment, the focal length of the camera, the camera aperture and/or of the focus of the camera.

13. A method in accordance with claim 1, characterized in that, within the framework of a recording plan, a plurality of cameras (13) are each controlled in accordance with a previously fixed camera tracking prescribed by the recording plan and the video data recorded by the individual cameras (13) in an order pre-set by the recording plan and in particular taking account of the camera tracking movements are compiled to form a program.

14. A method in accordance with claim 13, characterized in that the control of the cameras and the compilation of the program are carried out automatically in accordance with the previously prepared recording plan.

15. A method in accordance with claim 1, characterized in that an apparatus in accordance with any one of the preceding claims is used.

16. An apparatus for the recording of video data comprising
at least one camera (13) fixedly installed at a taking position (11) and controllable to make different settings;
a display device (15) disposed spatially remote from the taking position (11) at which an image (17) of the environment of the camera (13) can be presented;
a selection device (25) by means of which at least a plurality of picture elements (19) can be selected in the presented environmental image (17); p1 a control device (27) by means of which a control command sequence for the camera (13) can be generated from the selected picture elements (19); and
a data transmission sequence (29) via which the control command sequence can be transmitted to the camera (13) for the carrying out of the camera tracking.

17. An apparatus in accordance with claim 16, characterized in that the display device (15) and the control device (27) are components of a central station (31) with which a plurality of taking positions (11) with at least one respective camera (13) is associated.

18. An apparatus in accordance with claim 16, characterized in that a plurality of cameras (13) are provided which can be controlled within the framework of a recording plan by a central station (31) in each case in accordance with a previously determined camera tracking prescribed by the recording plan, with the central station (31) being made such that the video data recorded by the individual cameras (13) can be complied in an order pre-set by the recording plan and in particular while taking account of the camera tracking movements to form a program.

19. A method in accordance with claim 18, characterized in that the control of the cameras and the compilation of the program can be carried out automatically in accordance with the previously prepared recording plan.

20. An apparatus in accordance with claim 16, characterized in that the display device (15) includes a screen or a monitor.

21. An apparatus in accordance with claim 16, characterized in that the control device (27) includes a computer, in particular a PC.

22. An apparatus in accordance with claim 16, characterized in that the selection device (25) includes at least one computer peripheral device, in particular a keyboard and/or a mouse.

23. An apparatus in accordance with claim 16, characterized in that the data transmission path is provided in the form of a telecommunication link which in particular includes an existing mobile telephone network and/or a landline telephone network (39).

24. An apparatus in accordance with claim 16, characterized in that the camera (13) is pivotably supported about a vertical axis a and/or a horizontal axis b.

25. An apparatus in accordance with claim 16, characterized in that the camera (13) includes at least one detection device (33) with which a reference value serving as a reference point for a changeable camera setting can be detected.

26. An apparatus in accordance with claim 16, characterized in that it is operated or used in accordance with a method in accordance with any one of the claims 1 to 14.
